(19) United States
(12) Patent Application Publication
(10) Pub. No.: US 2024/0258021 A1
(43) Pub. Date: Aug. 1, 2024

(54) INDUCTOR AND POWER CONVERSION CIRCUIT

(71) Applicant: KABUSHIKI KAISHA TOSHIBA, Tokyo (JP)

(72) Inventors: Keigo ARITA, Kawasaki Kanagawa (JP); Yusuke HAYASHI, Yokohama Kanagawa (JP)

(73) Assignee: KABUSHIKI KAISHA TOSHIBA, Tokyo (JP)

(21) Appl. No.: 18/456,063

(22) Filed: Aug. 25, 2023

(30) Foreign Application Priority Data
Jan. 27, 2023 (JP) 2023-011112

(51) Int. Cl. H01F 27/30; H01F 27/26; H02M 3/335

(52) U.S. Cl. CPC H01F 27/306; H01F 27/26; H02M 3/335

(57) ABSTRACT

An inductor includes a magnetic member comprising a first core, a second core, a third core, and a connecting portion connecting the first core, the second core and the third core; a first winding wound around the first core; a second winding wound around the second core; and a third winding wound around the third core and connected between the first winding and the second winding. A direction of a magnetic flux generated in the third core by a current flowing through the first winding and a direction of a magnetic flux generated in the third core by a current flowing through the second winding are opposite to each other.

### CROSS-REFERENCE TO RELATED APPLICATION

This application is based upon and claims the benefit of priority from Japanese Patent Application No. 2023-011112, filed on Jan. 27, 2023; the entire contents of which are incorporated herein by reference.

### FIELD

Embodiments described herein relate generally to an inductor and a power conversion circuit.

### BACKGROUND

For example, JP2022-133822A has proposed an electric-field-coupling-type LLC resonant converter.

### BRIEF DESCRIPTION OF THE DRAWINGS

FIG. 1A is a schematic view of an inductor of an embodiment, and FIG. 1B is an equivalent circuit diagram of the inductor of the embodiment;

FIG. 2 is a circuit diagram of a power conversion circuit of the embodiment;

FIG. 3 is a schematic view of an inductor according to a modification of the embodiment;

FIG. 4 is a circuit diagram of a power conversion device of the embodiment;

FIG. 5A and FIG. 5B are schematic views showing current paths of the embodiment in FIG. 4;

FIG. 6 is an equivalent circuit diagram for a common mode current of the inductor of the embodiment; and

FIG. 7 is a circuit diagram of a power conversion circuit according to a modification of the embodiment.

### DETAILED DESCRIPTION

According to one embodiment, an inductor includes a magnetic member comprising a first core, a second core, a third core, and a connecting portion connecting the first core, the second core and the third core, the connecting portion allowing formation of a magnetic flux circulating between the first core and the third core, a magnetic flux circulating between the second core and the third core, and a magnetic flux circulating between the first core and the second core; a first winding wound around the first core; a second winding wound around the second core; and a third winding wound around the third core and connected between the first winding and the second winding, a direction of a magnetic flux generated in the third core by a current flowing through the first winding and a direction of a magnetic flux generated in the third core by a current flowing through the second winding being opposite to each other.

Hereinafter, embodiments will be described with reference to the drawings. In the drawings, the same configurations are denoted by the same reference signs.

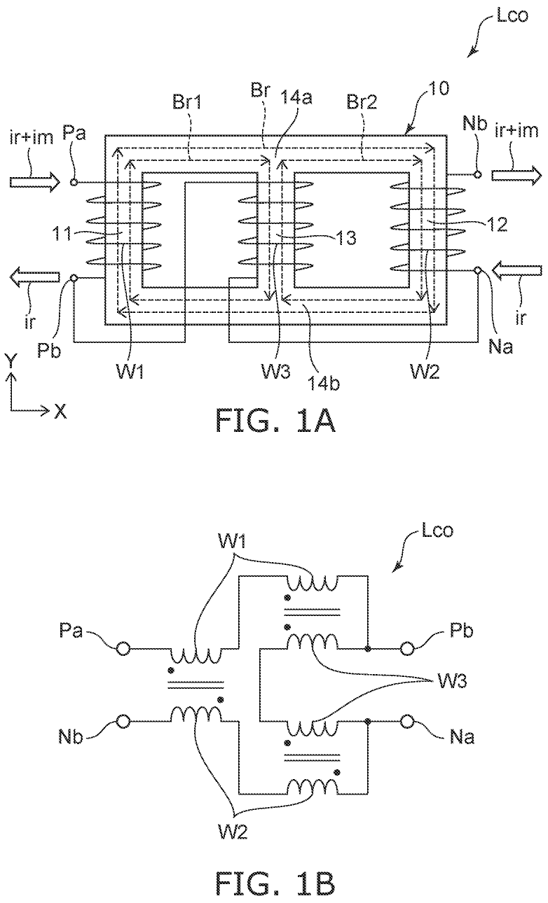

FIG. 1A is a schematic view of an inductor Lco of an embodiment, and FIG. 1B is an equivalent circuit diagram of the inductor Lco of the embodiment.

The inductor Lco of the embodiment includes a magnetic member 10, a first winding W1, a second winding W2, and a third winding W3.

The magnetic member 10 includes a first core 11, a second core 12, a third core 13, a first connecting portion 14a, and a second connecting portion 14b. For example, a MnZn-based ferrite can be used as the material of the magnetic member 10.

The first core 11 and the second core 12 are spaced apart from each other in a first direction X. The third core 13 is located between the first core 11 and the second core 12 in the first direction X. The first core 11, the second core 12, and the third core 13 extend in a second direction Y perpendicular to the first direction X. A distance between the first core 11 and the third core 13 (a shortest distance in the first direction X) is equal to a distance between the second core 12 and the third core 13 (a shortest distance in the first direction X).

The first connecting portion 14a and the second connecting portion 14b are spaced apart from each other in the second direction Y. The first connecting portion 14a and the second connecting portion 14b connect the first core 11, the second core 12, and the third core 13 to each other. The first connecting portion 14a is continuous with one end portion of each of the first core 11, the second core 12, and the third core 13, and extends in the first direction X. The second connecting portion 14b is continuous with the other end portion of each of the first core 11, the second core 12, and the third core 13, and extends in the first direction X.

The first winding W1 is wound around the first core 11, the second winding W2 is wound around the second core 12, and the third winding W3 is wound around the third core 13. The first winding W1, the second winding W2, and the third winding W3 are, for example, copper wires having the same diameter. The third winding W3 is connected between the first winding W1 and the second winding W2. One end of the third winding W3 is connected to one end Pb of the first winding W1, and the other end of the third winding W3 is connected to one end Na of the second winding W2.

The first winding W1, the second winding W2, and the third winding W3 are magnetically coupled to each other via the magnetic member 10. Due to a current flowing through the first winding W1, a magnetic flux Br1 circulating between the first core 11 and the third core 13 via the first connecting portion 14a and the second connecting portion 14b is formed. Due to a current flowing through the second winding W2, a magnetic flux Br2 circulating between the second core 12 and the third core 13 via the first connecting portion 14a and the second connecting portion 14b is formed. According to the embodiment, a direction of the magnetic flux Br1 generated in the third core 13 by the current flowing through the first winding W1 and a direction of the magnetic flux Br2 generated in the third core 13 by the current flowing through the second winding W2 are opposite to each other. By combining the magnetic flux Br1 with the magnetic flux Br2, a magnetic flux Br that circulates between the first core 11 and the second core 12 via the first connecting portion 14a and the second connecting portion 14b is formed.

The inductor Lco of the embodiment can be used in a power conversion circuit 100 described below.

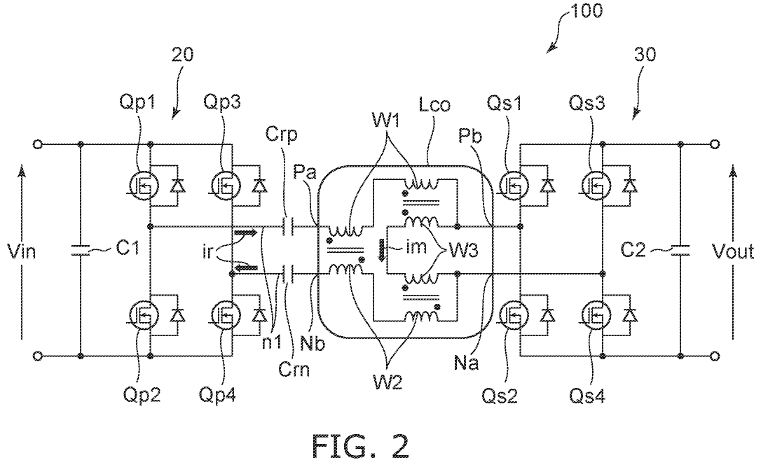

FIG. 2 is a circuit diagram of the power conversion circuit 100 of the embodiment.

The power conversion circuit 100 includes an inverter circuit 20, an output circuit 30, the above-described inductor Lco connected between the inverter circuit 20 and the output circuit 30, and a capacitor connected between an output node n1 of the inverter circuit 20 and the inductor Lco.

The capacitor is connected between the output node n1 of the inverter circuit 20 and at least one of the first winding W1 and the second winding W2. In the embodiment, the capacitor includes a first capacitor Crp connected to the first winding W1 and a second capacitor Crn connected to the second winding W2.

In the embodiment, as an example of the power conversion circuit 100, an electric-field-coupling-type LLC resonant converter is described in which the inverter circuit 20 and the output circuit 30 are electrically insulated by the first capacitor Crp and the second capacitor Crn.

The first capacitor Crp, the second capacitor Crn, and the inductor Lco form a resonant circuit in the LLC resonant converter. In the resonant circuit, the first core 11, the first winding W1, the second core 12, and the second winding W2 function as resonant inductors, and the third core 13 and the third winding W3 function as a parallel inductor.

The inverter circuit 20 is, for example, a full-bridge circuit shown in FIG. 2. The inverter circuit 20 includes switching elements Qp1, Qp2, Qp3, and Qp4, and an input capacitor C1. The switching element Qp1 and the switching element Qp4 are simultaneously turned on and off. The switching element Qp2 and the switching element Qp3 are simultaneously turned on and off. The inverter circuit 20 generates a rectangular wave voltage by alternately turning on and off the switching elements Qp1 and Qp4 and the switching elements Qp2 and Qp3. The switching elements Qp1, Qp2, Qp3, and Qp4 are, for example, semi-conductive elements such as metal-oxide-semiconductor field effect transistors (MOSFET) or insulated gate bipolar transistors (IGBT). A set of the switching elements Qp1 and Qp2 connected in series and a set of the switching elements Qp3 and Qp4 connected in series are connected in parallel between two input terminals of the inverter circuit 20. Two output terminals n1 of the inverter circuit 20 are a node to which the switching elements Qp1 and Qp2 are connected and a node to which the switching elements Qp3 and Qp4 are connected.

The first capacitor Crp is connected between one output node n1 of the inverter circuit 20 and the other end Pa of the first winding W1. The second capacitor Crn is connected between the other output node n1 of the inverter circuit 20 and the other end Nb of the second winding W2.

The output circuit 30 can be implemented by a full-bridge circuit shown in FIG. 2, for example. The output circuit 30 includes switching elements Qs1, Qs2, Qs3, Qs4, and an output capacitor C2. The switching elements Qs1, Qs2, Qs3, and Qs4 are, for example, semi-conductive elements such as MOSFETs or IGBTs. A set of the switching elements Qs1 and Qs2 connected in series and a set of the switching elements Qs3 and Qs4 connected in series are connected in parallel between two output terminals of the output circuit 30. The two input terminals of the output circuit 30 are a node to which the switching elements Qs1 and Qs2 are connected and a node to which the switching elements Qs3 and Qs4 are connected.

A DC voltage Vin is input to the input terminals of the inverter circuit 20, and a DC voltage Vout is output to the output terminals of the output circuit 30. An AC voltage output from the output terminals of the inverter circuit 20 is input to the input terminals of the output circuit 30.

In the related art, in the LLC resonant converter, individual magnetic components are used as two resonant inductors and one parallel inductor. Therefore, the three magnetic components occupy a large volume of the LLC resonant converter, which is a bottle neck in reducing a size of the LLC resonant converter.

According to the embodiment, two windings (the first winding W1 and the second winding W2) constituting the resonant inductors and one winding (the third winding W3) constituting the parallel inductor are wound around one magnetic member 10, thereby constituting the inductor Lco as one magnetic component. Accordingly, it is possible to reduce the size of the inductors and the LLC resonant converter.

Current waveforms flowing through the resonant inductor and the parallel inductor are different from each other. A resonance current ir flowing through the resonant inductor is a sinusoidal current, and a current im flowing through the parallel inductor is a triangular-wave current. The resonant inductor and the parallel inductor are required to operate independently such that the magnetic flux generated by the resonant inductor and the magnetic flux generated by the parallel inductor do not interfere with each other.

According to the embodiment, the direction of the magnetic flux Br1 generated in the third core 13 by the resonance current ir flowing through the first winding W1 and the direction of the magnetic flux Br2 generated in the third core 13 by the resonance current ir flowing through the second winding W2 are opposite to each other, and the magnetic fluxes generated in the third core 13 by the resonance current ir cancel each other out. The third winding W3 is not affected by the magnetic fluxes generated by the resonant inductors.

In addition, even when the magnetic flux caused by the current flowing through the third winding W3 interlinks the first core 11 and the second core 12, currents excited in the first winding W1 and the second winding W2 cancel each other out. The first winding W1 and the second winding W2 are not affected by the magnetic flux generated by the parallel inductor.

Accordingly, according to the embodiment, an independent operation of each of the resonant inductors and the parallel inductor can be implemented while reducing the size by winding the three windings W1, W2, and W3 around one magnetic member 10.

By equalizing a magnetic flux density of the resonance current flowing through the first winding W1 and a magnetic flux density of the resonance current flowing through the second winding W2, the magnetic fluxes generated in the third core 13 by the resonance current can cancel each other out. For example, by equalizing a magnetic path length of the magnetic flux Br1 circulating between the first core 11 and the third core 13 and a magnetic path length of the magnetic flux Br2 circulating between the second core 12 and the third core 13, making a cross-sectional area of the first core 11 the same as a cross-sectional area of the second core 12 and equalizing the number of turns of the first winding W1 and the number of turns of the second winding W2, the magnetic flux density of the resonance current flowing through the first winding W1 and the magnetic flux density of the resonance current flowing through the second winding W2 are easily made the same.

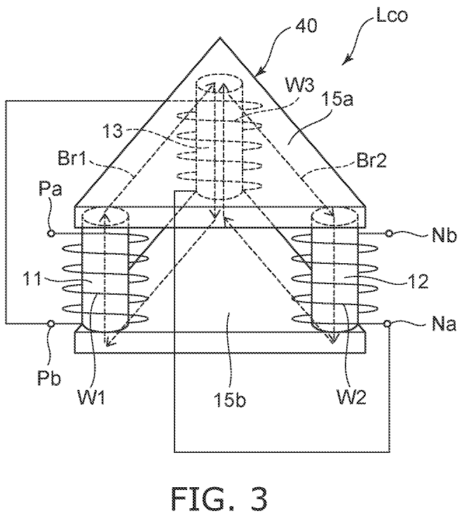

FIG. 3 is a schematic view of the inductor Lco according to a modification of the embodiment.

The inductor Lco also includes the magnetic member 10, the first winding W1, the second winding W2, and the third winding W3. The magnetic member 10 includes the first core 11, the second core 12, the third core 13, a first connecting portion 15a, and a second connecting portion 15b. The first core 11, the second core 12, and the third core 13 are located at vertexes of a triangle in a plan view. The triangle is, for example, an isosceles triangle having the third core 13 at a vertical angle. In the plan view, the third core is located on a perpendicular bisector that connects the first core 11 and the second core 12.

A distance (a shortest distance) between the first core 11 and the third core 13 is equal to a distance (a shortest distance) between the second core 12 and the third core 13. The first connecting portion 15a and the second connecting portion 15b connect the first core 11, the second core 12, and the third core 13 to each other. The first connecting portion 15a is provided at one end portion of each of the first core 11, the second core 12, and the third core 13, and the second connecting portion 15b is provided at the other end portion of each of the first core 11, the second core 12, and the third core 13.

In the plan view, the first connecting portion 15a and the second connecting portion 15b may have a shape of the triangle or a shape including the triangle. When a path length between the first core 11 and the third core 13 and a path length between the second core 12 and the third core 13 are equal to each other on the first connecting portion 15a and the second connecting portion 15b, the first connecting portion 15a and the second connecting portion 15b may have a shape extending radially from the inside of the triangle toward the first core 11, the second core 12, and the third core 13 in the plan view. The first connecting portion 15a and the second connecting portion 15b extend along a plane perpendicular to a direction in which the third core 13 extends.

The first winding W1 is wound around the first core 11, the second winding W2 is wound around the second core 12, and the third winding W3 is wound around the third core 13. The first winding W1, the second winding W2, and the third winding W3 are magnetically coupled to each other via the magnetic member 10. Due to a current flowing through the first winding W1, the magnetic flux Br1 circulating between the first core 11 and the third core 13 via the first connecting portion 15a and the second connecting portion 15b is formed. Due to a current flowing through the second winding W2, the magnetic flux Br2 circulating between the second core 12 and the third core 13 via the first connecting portion 15a and the second connecting portion 15b is formed. Also in the example in FIG. 3, a direction of the magnetic flux Br1 generated in the third core 13 by the current flowing through the first winding W1 and a direction of the magnetic flux Br2 generated in the third core 13 by the current flowing through the second winding W2 are opposite to each other. Accordingly, it is possible to achieve independent operations of resonant inductors and a parallel inductor while reducing the size by winding the three winding wires W1, W2, and W3 around one magnetic member 10.

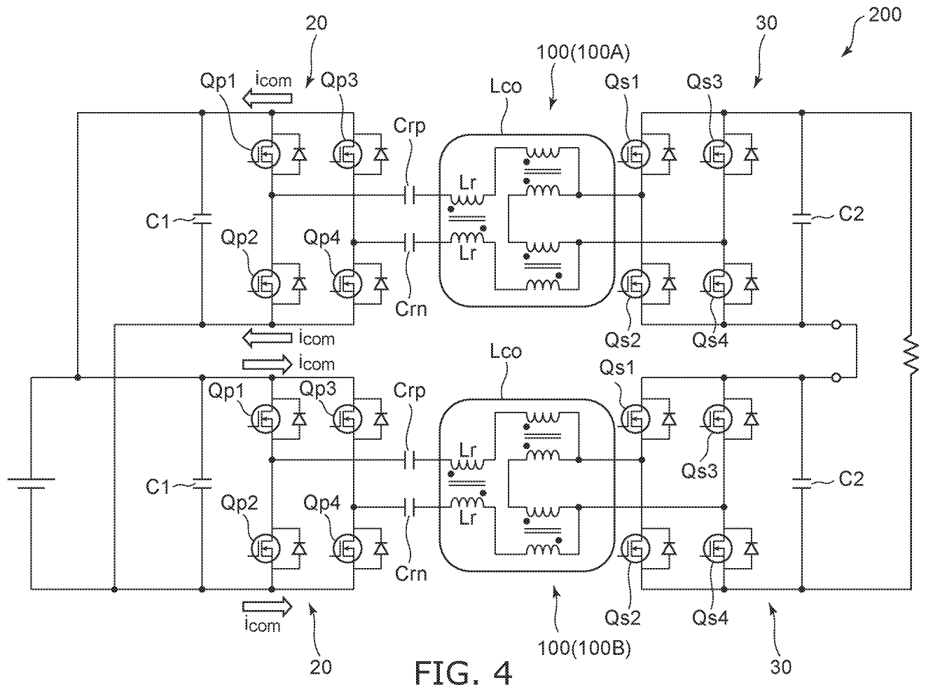

FIG. 4 is a circuit diagram of a power conversion device 200 of the embodiment.

The power conversion device 200 shown in FIG. 4 has a building block configuration (input parallel output series (IPOS)) in which input terminals of the multiple power conversion circuits 100 are connected in parallel and output terminals of the multiple power conversion circuits 100 are connected in series. The power conversion device 200 at least includes a first power conversion circuit 100A and a second power conversion circuit 100B. The first power conversion circuit 100A and the second power conversion circuit 100B may be simply referred to as the power conversion circuit 100 without being distinguished from each other. Each power conversion circuit 100 is an LLC resonant converter, and includes the above-described configuration (the inverter circuit 20, the first capacitor Crp, the second capacitor Crn, the inductor Lco, and the output circuit 30). The power conversion device 200 is not limited to the configuration in FIG. 4, and includes a configuration in which input terminals of the multiple power conversion circuits 100 are connected in series and a configuration in which output terminals of the multiple power conversion circuits 100 are connected in parallel.

Generally, a passive component such as an inductor and a capacitor has an error of ±5% to ±20% in a nominal value. Therefore, in an LLC resonant circuit implemented using an inductor and a capacitor, impedance characteristics vary depending on the error of the passive component. When a building block configuration is implemented by using multiple electric-field-coupling-type LLC converters, the variation in the impedance characteristics is a main cause of imbalance in currents flowing through the power conversion circuits. A countermeasure is required for the imbalance in currents in the power conversion circuits since there is a risk of causing breakdown of a semi-conductive element or the like due to concentration of a current in a specific unit.

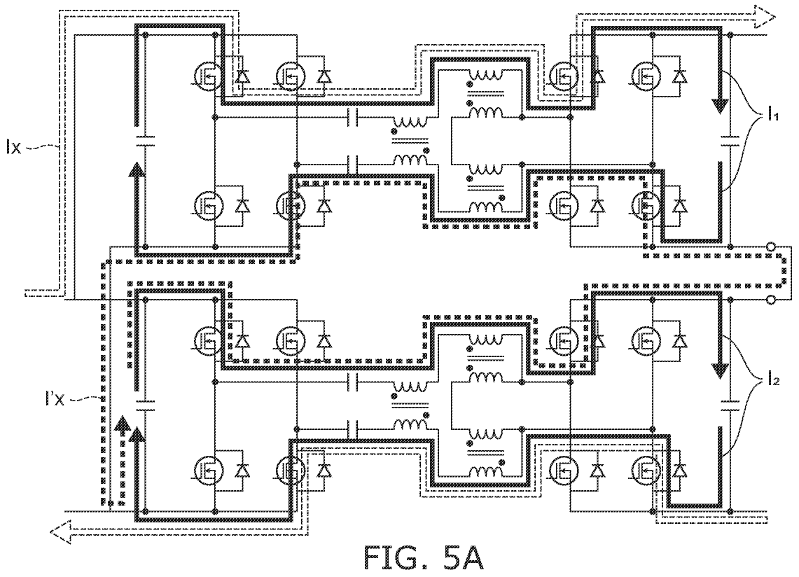

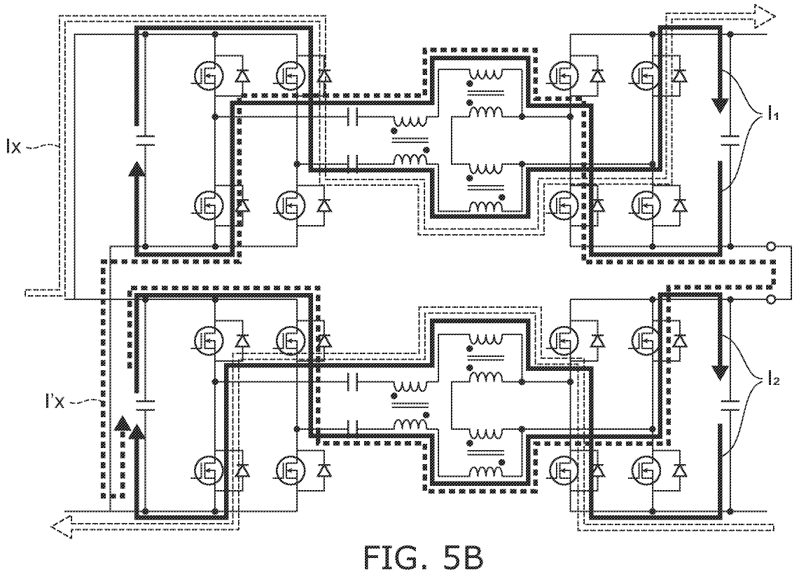

FIGS. 5A and 5B show current paths of the first power conversion circuit 100A and the second power conversion circuit 100B in the building block configuration in FIG. 4. FIG. 5A shows a current path in a case where the switching element Qp1 and the switching element Qp4 are simultaneously turned on, and FIG. 5B shows a current path in a case where the switching element Qp2 and the switching element Qp3 are simultaneously turned on. I₁ and I₂ are current paths at the time when two converter units independently perform a conversion operation, and Ix and I′x indicate current paths that appear when taking a building block configuration. From FIGS. 5A and 5B, when two capacitively coupled converters are in the IPOS connection, a circuit parameter of the LLC resonant circuit of each converter unit affects a circuit operation of the other converter unit via Ix and I′x. When the impedance characteristics of the resonant circuits are different, Ix and I′x indicate different values, which is a main cause of imbalance in currents flowing in a forward path and a backward path of each converter unit. In this case, since currents in the forward path and the backward path flowing through each power conversion circuit 100 in FIG. 4 are different from each other, the imbalance in current can be considered to have the same property as imbalance caused by a common mode current icom of a switching frequency component. A switching frequency of the electric-field-coupling-type LLC converter is often set close to a resonance frequency of the LLC resonant circuit. Therefore, the impedance of the converter at the switching frequency is low and is likely to be affected by the common mode current icom having the switching frequency component. According to the embodiment, since the first winding W1 and the second winding W2 are magnetically coupled via the magnetic member 10, magnetic fluxes generated by the common mode current cancel each other out, and inductance is not caused.

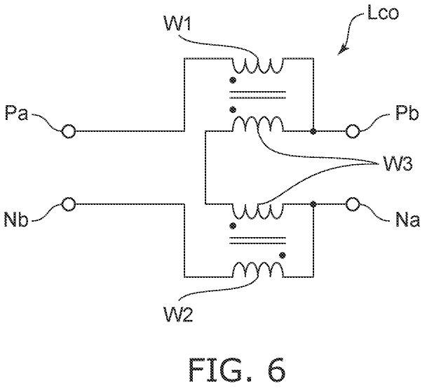

FIG. 6 shows an equivalent circuit for a common mode current of the inductor Lco. Since inductance is not caused in a coupling portion between the first winding W1 and the second winding W2, inductance for the common mode current is reduced. Accordingly, common mode impedance of the resonant circuit implemented by the first capacitor Crp, the second capacitor Crn, and the inductor Lco has a resonance frequency at a high-frequency side away from the switching frequency. Accordingly, since the resonance frequency and the switching frequency do not coincide with each other, the common mode impedance of the resonant circuit including the inductor Lco generates high impedance at the switching frequency. Therefore, even if the parameters of the resonant circuit are unbalanced in the building block configuration, the imbalance in the currents flowing through the power conversion circuits 100 can be suppressed. In addition, it is possible to simultaneously achieve a countermeasure against common mode noise of the switching frequency component.

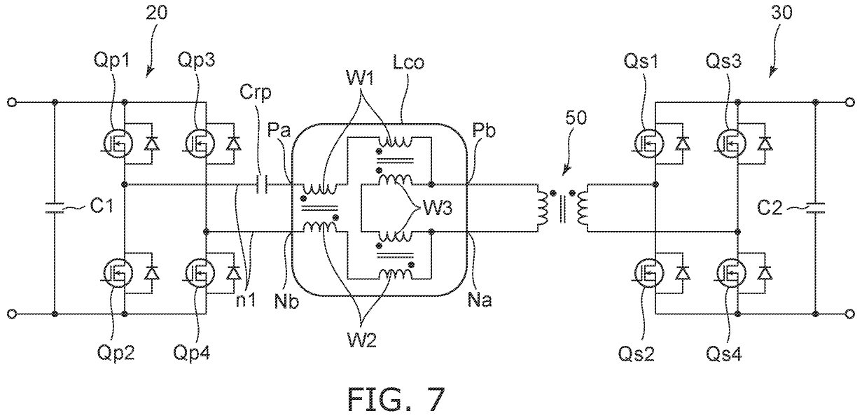

Only one of the first capacitor Crp and the second capacitor Crn may be used. For example, in the example shown in FIG. 7, the first capacitor Crp is provided but the second capacitor Crn is not provided.

A voltage conversion circuit shown in FIG. 7 includes an insulating-type transformer 50 connected between the inductor Lco and the output circuit 30. The inverter circuit 20 and the output circuit 30 are electrically insulated by the insulating-type transformer 50. That is, the voltage conversion circuit shown in FIG. 7 is a magnetic-coupling-type LLC resonant converter.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. An inductor comprising:
a magnetic member comprising a first core, a second core, a third core, and a connecting portion connecting the first core, the second core and the third core, the connecting portion allowing formation of a magnetic flux circulating between the first core and the third core, a magnetic flux circulating between the second core and the third core, and a magnetic flux circulating between the first core and the second core;
a first winding wound around the first core;
a second winding wound around the second core; and
a third winding wound around the third core and connected between the first winding and the second winding,
a direction of a magnetic flux generated in the third core by a current flowing through the first winding and a direction of a magnetic flux generated in the third core by a current flowing through the second winding being opposite to each other.

2. The inductor according to claim 1, wherein
the first core and the second core are spaced apart from each other in a first direction,
the third core is located between the first core and the second core in the first direction, and
a distance between the first core and the third core is equal to a distance between the second core and the third core.

3. The inductor according to claim 1, wherein
the first core, the second core, and the third core are located at vertexes of a triangle in a plan view, and
a distance between the first core and the third core is equal to a distance between the second core and the third core.

4. The inductor according to claim 1, wherein
a cross-sectional area of the first core is same as a cross-sectional area of the second core.

5. The inductor according to claim 1, wherein
a number of turns of the first winding is equal to a number of turns of the second winding.

6. A power conversion circuit comprising:
an inverter circuit;
an output circuit;
the inductor according to claim 1 connected between the inverter circuit and the output circuit; and
a capacitor connected between an output node of the inverter circuit and at least one of the first winding and the second winding.

7. The circuit according to claim 6, wherein
the capacitor comprises a first capacitor connected to the first winding and a second capacitor connected to the second winding.

8. The circuit according to claim 7, further comprising:
an insulating-type transformer connected between the inductor and the output circuit.

9. The circuit according to claim 6, wherein
the first core and the second core are spaced apart from each other in a first direction,
the third core is located between the first core and the second core in the first direction, and
a distance between the first core and the third core is equal to a distance between the second core and the third core.

10. The circuit according to claim 6, wherein
the first core, the second core, and the third core are located at vertexes of a triangle in a plan view, and
a distance between the first core and the third core is equal to a distance between the second core and the third core.

11. The circuit according to claim 6, wherein
a cross-sectional area of the first core is same as a cross-sectional area of the second core.

12. The circuit according to claim 6, wherein
a number of turns of the first winding is equal to a number of turns of the second winding.
